(19) United States
(12) Patent Application Publication
(10) Pub. No.: US 2017/0219865 A1
(43) Pub. Date: Aug. 3, 2017

(54) Writing Board, Electronic Writing Device and Method for Fabricating the Same

(71) Applicant: BOE Technology Group Co., Ltd., Beijing (CN)

(72) Inventor: Xin Gu, Beijing (CN)

(21) Appl. No.: 15/335,675

(22) Filed: Oct. 27, 2016

(30) Foreign Application Priority Data
Feb. 3, 2016 (CN) 201610078130.6

(51) Int. Cl. G02F 1/1333; G06F 3/0354; G02F 1/1341; G02F 1/1343

(52) U.S. Cl. CPC G02F 1/13338; G02F 1/134309; G02F 1/13439; G06F 3/03545; G02F 1/1341; G02F 2001/134345

(57) ABSTRACT

A writing board, comprising: a first substrate and a second substrate opposed to each other, and liquid crystals filled between the first substrate and the second substrate, wherein the first substrate comprises a first electrode, the second substrate comprises a second electrode, the first electrode comprises a plurality of first sub-electrodes, and the first sub-electrodes are configured to accept touch control operations. An electronic writing device and a method for fabricating a writing board are also provided.

This application claims priority to and the benefit of Chinese Patent Application No. 201610078130.6 filed on Feb. 3, 2016, which application is incorporated herein in its entirety.

### TECHNICAL FIELD

Embodiments of the disclosure relate to a writing board, an electronic writing device and a method for fabricating the same.

### BACKGROUND

As a more environmentally-friendly and convenient writing medium, electronic writing boards attract much attention from people. When pressure is applied to an electronic writing board, corresponding patterns will appear in the pressed region. Thereby, users can achieve writing operation by pressing different positions through an operation object.

When texts on the writing board needs to be erased, it is possible to electrify the electronic writing board to erase all the written information. However, conventional writing board can only erase all texts and patterns on the writing board once. In this sense, it is not convenient for the user to selectively erase texts and patterns.

### SUMMARY

According to at least one embodiment in the disclosure, a writing board is provided, comprising: a first substrate and a second substrate opposed to each other, and liquid crystals filled between the first substrate and the second substrate, wherein the first substrate comprises a first electrode, the second substrate comprises a second electrode, the first electrode comprises a plurality of first sub-electrodes, and the first sub-electrodes are configured to accept touch control operations.

According to at least one embodiment in the disclosure, an electronic writing device is provided, comprising a writing board and a stylus, wherein the writing board comprises: a first substrate and a second substrate opposed to each other, and liquid crystals filled between the first substrate and the second substrate, the first substrate comprises a first electrode, the second substrate comprises a second electrode, the first electrode comprises a plurality of first sub-electrodes, and the first sub-electrodes is configured to accept touch of the stylus ; and the stylus comprises a first nib and the first nib is conductive.

According to at least one embodiment in the disclosure, a method for fabricating a writing board is provided, comprising: fabricating a first substrate, wherein the first substrate comprises a first electrode, the first electrode comprises a first sub-electrode, and the first sub-electrode is configured to accept touch control operations; fabricating a second substrate comprising a second electrode; and injecting liquid crystals between the first substrate and the second substrate so as to form the writing board.

### BRIEF DESCRIPTION OF THE DRAWINGS

FIG. 1 schematically illustrates a writing board;

FIG. 2 schematically illustrates different states of cholesteric liquid crystals with pressure or without pressure;

FIG. 3a illustrates a first schematic diagram of a writing board in embodiments of the disclosure;

FIG. 3b illustrates a second schematic diagram of a writing board in embodiments of the disclosure;

FIG. 4 illustrates a first schematic diagram of first sub-electrode of a first electrode in embodiments of the disclosure;

FIG. 5 illustrates a second schematic diagram of first sub-electrode of a first electrode in embodiments of the disclosure;

FIG. 6 illustrates a second schematic diagram of a writing board in embodiments of the disclosure;

FIG. 7 schematically illustrates an electronic writing device in embodiments of the disclosure;

FIG. 8a schematically illustrates a method for fabricating a writing board in embodiments of the disclosure; and

FIG. 8b schematically illustrates a fabricating flow chart of a first substrate of a writing board in embodiments of the disclosure.

### DETAIL DESCRIPTION

Thereafter will describe the solutions according to the embodiments of the present disclosure clearly and fully in connection with the drawings in the embodiments of the present disclosure. Obviously, the embodiments described are only a part of embodiments of the present disclosure instead of all of the embodiments.

In addition, the terms “first”, “second” are only used to depict objective, should not be considered to indicate or suggest relative importance or imply the amount of the indicated technical features. Therefore, the features limited with “first”, “second” may indicate or imply including one or more the features. In the description of this invention, the meaning of “a plurality of” is two or more than two except additional statement.

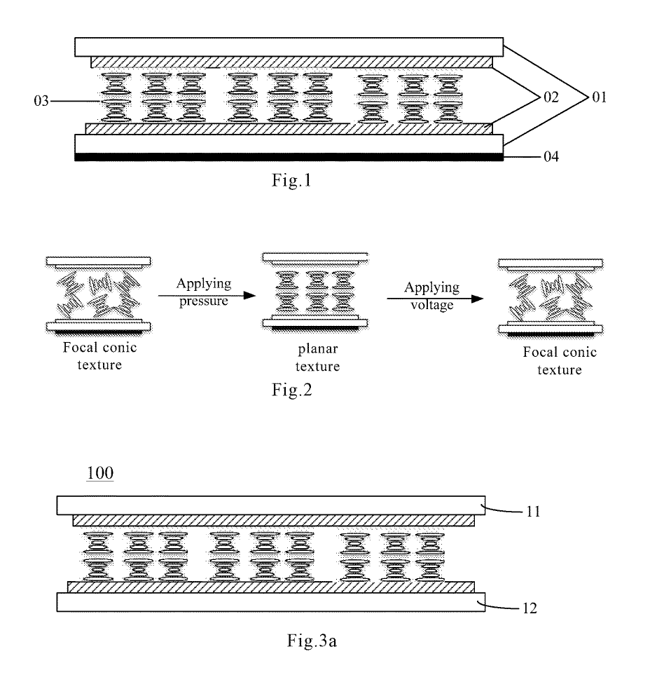

FIG. 1 schematically illustrates a liquid crystal writing board such as a cholesteric liquid crystal writing board or other type of liquid crystal writing board. In the following, the disclosure will be described taking cholesteric liquid crystal writing boards as an example.

A cholesteric liquid crystal writing board comprises top and bottom transparent electrode substrates 01, top and bottom liquid crystal alignment layers 02, a cholesteric liquid crystal layer 03 disposed between the top and bottom liquid crystal alignment layers 02, and a base 04 such as a black base.

As illustrated in FIG. 2, the cholesteric liquid crystal are relatively sensitive to pressure. The cholesteric liquid crystal presents a focal conic texture when no pressure is applied thereon. In this condition the cholesteric liquid crystal writing board looks like a black screen with no display. The cholesteric liquid crystals presents a planar texture when pressure is applied thereon (e.g., when clicked by a stylus). In this condition, the cholesteric liquid crystals selectively reflect white light; as a result, regions under pressure will display corresponding patterns.

Still referring to FIG. 2, when it is needed to erase texts on the cholesteric liquid crystal writing board, a voltage may be applied to the top and bottom transparent electrode substrates 01 such that the cholesteric liquid crystals transform from planar texture to focal conic texture under the voltage difference and restore to a black screen.

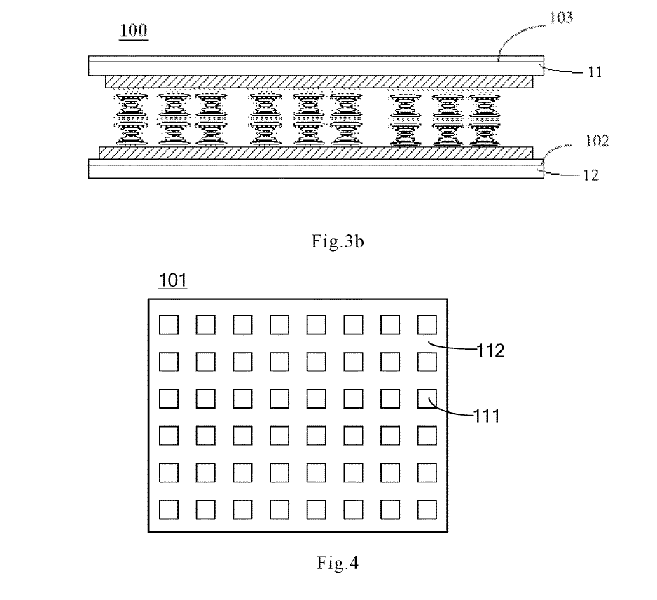

According to an embodiment of the disclosure, a writing board 100 as illustrated in FIG. 3a comprises: a first substrate 11 and a second substrate 12 disposed as opposed to each other, and cholesteric liquid crystals filled between the first substrate 11 and the second substrate 12; herein the first substrate 11 comprises a first electrode 101, the second substrate 12 comprises a second electrode 102.

Cholesteric liquid crystals are filled between the first substrate 11 and the second substrate 12. Moreover, a liquid crystal alignment layer may also be disposed between the first substrate 11 and the second substrate 12, which will not be limited in the embodiment of the disclosure.

As illustrated in FIG. 4, the first electrode 101 comprises a plurality of first sub-electrodes 111 distributed in various positions of the first electrode 101. The first sub-electrodes 111 may be made of transparent conductive material, and the plurality of the first sub-electrodes 111 may be arranged in an array. Moreover, the first sub-electrodes 111 are configured to accept touch control operations from an operation object such as a stylus. As an example, the first sub-electrodes may include contact surfaces contacting the stylus. Other layers may also be disposed between the first sub-electrodes 111 and the stylus, such as a protection layer of the first sub-electrodes 111, etc.

According to an embodiment of the disclosure, the liquid crystals are cholesteric liquid crystals. Cholesteric liquid crystal molecules are flat-shaped and arranged in layers. Molecules in a layer are parallel to each other, with macroaxis of the molecules being parallel to a plane of the layer, while directions of macroaxis of molecules in different layers varying slightly, the molecules are arranged into a spiral structure along a normal line direction of the layers. A pitch of screw of cholesteric liquid crystals is 300 nm approximately, which is in the same level as visible wavelength, and the pitch of screw varies with ambient pressure and electric field condition. As a result, it is possible to modulate external light through adjusting the pitch of screw of cholesteric liquid crystals. It can be known by those skilled in the art that the liquid crystal may employ other shape of liquid crystal, and the disclosure is described by taking cholesteric liquid crystals only as an example.

As an example, it is possible to control the texts and patterns on the writing board 100 through the variation relationship between the screw of cholesteric liquid crystals and the ambient pressure. As illustrated in FIG. 2, the cholesteric liquid crystals presents a focal conic texture when no pressure is applied to the writing board 100. In this case the writing board 100 presents a black screen with no display. The cholesteric liquid crystals presents a planar texture when pressure is applied on the writing board 100 (e.g., being clicked by a stylus). In this case the cholesteric liquid crystals selectively reflect white light; as a result, regions in the writing board 100 under pressure present corresponding patterns.

Moreover, it is also possible to control the texts and patterns on the writing board 100 through the variation relationship between the screw of cholesteric liquid crystals and the electric field. When the cholesteric liquid crystals present a planar texture, an electric field may be formed between the first electrode 101 and the second electrode 102, by applying a voltage on the first electrode 101 and the second electrode 102 of the writing board 100. In this case, the cholesteric liquid crystals transform from planar texture to focal conic texture under the influence of the electric field, thereby erasing the texts and patterns on the writing board 100.

In the embodiment of the disclosure, the first electrode 101 comprises first sub-electrodes 111 arranged in an array, and the first sub-electrodes 111 have a contact surface contacting the stylus. Based on the above principle, when the writing board 100 already has patterns displayed thereon under the effect of pressure and an electrified end of the stylus contacts at least one of the first sub-electrodes 111 of the first electrode 101, a potential difference will be formed between the first sub-electrodes 111 contacting the stylus and the second electrode 102, thus forming an electric field between the first sub-electrodes 111 and the second electrode 102. It thereby allows the cholesteric liquid crystals corresponding to the contact position to transform from planar texture to focal conic texture. Moreover, the cholesteric liquid crystals having a focal conic texture do not reflect light. Due to the above fact, the patterns on the contact position may be erased, thereby erasing the texts and patterns on the writing board 100 selectively can be achieved.

Furthermore, still referring to FIG. 4, the first substrate 11 further comprises a non-conducting portion 112 separating the first sub-electrodes 111 from each other. As an example, the non-conducting portion 112 is disposed on a plane of the first electrode 101. Thereby, when the first sub-electrodes 111 contact the electrified stylus, the non-conducting portion 112 around the first sub-electrodes 111 separates the first sub-electrodes 111 such that the electric field is formed only between the first sub-electrodes 111 contacting the electrified stylus and the second electrode 102, thereby erasing the patterns on the contact position accurately can be achieved.

It is obvious that FIG. 4 only illustrates a design solution for separating the first sub-electrodes 111 and the non-conducting portion 112 from each other. It can be understood that a person skilled in the art can disposed the first sub-electrodes 111 on the plane of the first electrode 101 and the non-conducting portion 112 according to practical experience. As an example illustrated in FIG. 5, the first sub-electrodes 111 and the non-conducting portion 112 may be separated from each other and arranged in an array, form the first electrode 101.

The first sub-electrodes 111 of the first electrode 101 and the non-conducting portion 112 may comprise a polymer of poly (3,4-ethylenedioxythiophene), i.e., PEDOT.

PEDOT has such properties as having simple molecular structure, small energy gap, high conductivity, etc. As a result, PEDOT is widely used in the research areas of organic thin film solar cell material, OLED material, electrochromic material, transparent electrode material, etc.

Exemplarily, the first sub-electrodes 111 are square-shaped, a side length of the first sub-electrodes 111 may be 50 μm-100 μm, and a distance between two adjacent first sub-electrodes 111 is 30 μm-50 μm.

It can be contemplated that the shape of the first sub-electrodes 111 may also be configured as a circle, an irregular polygon, etc. Those skilled in the art may configure the shape and size of the first sub-electrodes 111 according to practical experience, which will not be limited in the embodiment of the disclosure.

Moreover, when a stylus 21 is used to contact a certain position on the writing board 100 to erase the pattern on the contact position, in case the arrangement of the plurality of the first sub-electrodes 111 of the first electrode 101 is relatively intensive, the electric field distribution around the contact position will be affected so as to affect the accuracy of erasure. However, if the arrangement of the plurality of the first sub-electrodes 111 of the first electrode 101 is relatively sparse, the continuity of the erasing of the pattern on the writing board 100 cannot be guaranteed. In consideration of the above fact, the distance between two adjacent first sub-electrodes 111 is configured as 30 μm-50 μm in the embodiment of the disclosure. As an example, a side length of the non-conducting portion 112 illustrated in FIG. 5 is 30 μm-50 μm, thus the accuracy and continuity of the erasing all can be guaranteed.

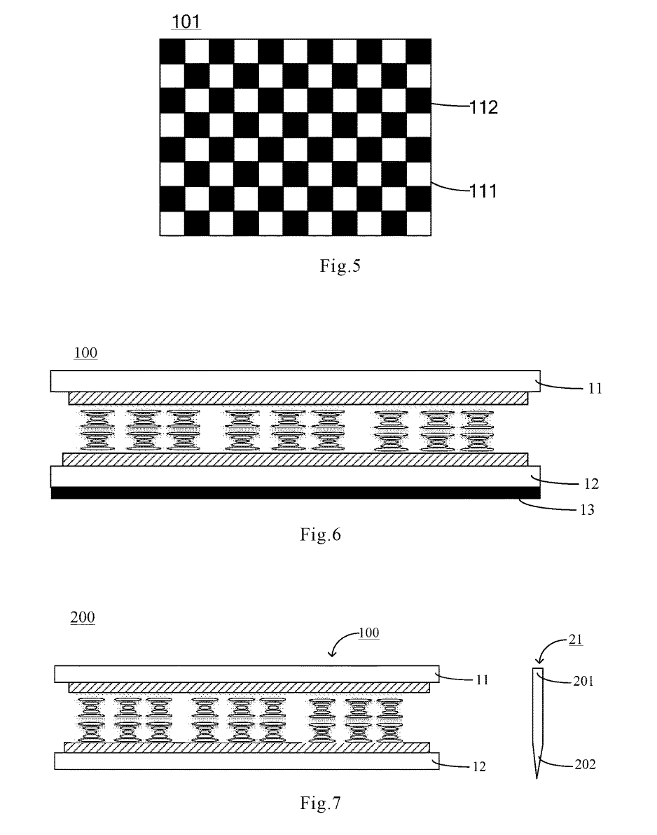

Furthermore, as illustrated in FIG. 6, a base 13 is disposed on a side of the second substrate 12, this side is far from the first substrate 11, and the base 13 is configured to allow the writing board 100 to be black when not under pressure or not electrified.

Apparently, the black base 13 may be replaced by a red base, a blue base or other colors base, such that a background of the writing board 100 may present different colors.

FIG. 3b illustrates a second schematic diagram of a writing board in embodiments of the disclosure. With reference to FIG. 3b, according to an embodiment of the disclosure, the second substrate 12 may comprise a base substrate (such as a transparent glass substrate) and the second electrode 102, the second electrode 102 is disposed on a side of the base substrate close to the first substrate 11, and the black base 13 is disposed on a side of the base substrate far from the first substrate 11.

It can be contemplated that the first substrate 11 may further comprise a base substrate 103 (such as a transparent glass substrate). As an example, a plurality of through holes may be disposed on the base substrate and the first sub-electrodes 111 are disposed in each of the through holes, which will not be limited in the embodiment of the disclosure.

It can be understood that, the first substrate 11 or the second substrate 12 may be a flexible substrate, thereby a flexible display can be implemented, which will not be limited in the embodiments of the disclosure.

As illustrated in FIG. 7, an embodiment of the disclosure further provides an electronic writing device 200 comprising any of the above writing board 100 and a stylus 21. As an example, the stylus 21 comprises a first nib 201 and the first nib 201 is electrified. The stylus 21 may further comprise a second nib 202 and the second nib 202 is not electrified.

When the first nib 201 contacts the first sub-electrodes 111, an electric potential difference may be formed between the first sub-electrodes 111 in the contact position and the second electrode 102, thus an electric field between the contact position and the second electrode 102 is formed, thereby the cholesteric liquid crystals corresponding to the contact position is transformed from planar texture to focal conic texture. Moreover, the cholesteric liquid crystals having a focal conic texture do not reflect light. Due to the above fact, the patterns on the contact surface may be erased, thereby the texts and patterns on the writing board 100 can be erased selectively.

The second nib 202 is configured to apply pressure on the first substrate 11 of the writing board 100. As the second nib 202 is not electrified, the second nib 202 may be used to write or draw on the writing board 100.

Furthermore, a battery is disposed in the stylus 21 and configured for providing a voltage for the first nib 201.

Thereby, in comparison with connecting the stylus 21 to a power socket directly, using a battery to provide a voltage for the first nib 201 is more convenient.

Moreover, a switch unit can be disposed in the stylus 21, and the switch unit, the battery and the first nib 201 are connected in series.

By this means, the switch unit may control the on-off of the serial circuit formed by the switch unit, the battery and the first nib. When an erasure is needed, the switch unit may be switched on so as to conduct the serial circuit, thus the battery can provides a voltage for the first nib 201. When no erasure is needed, the switch unit may be switched off to save power of the battery.

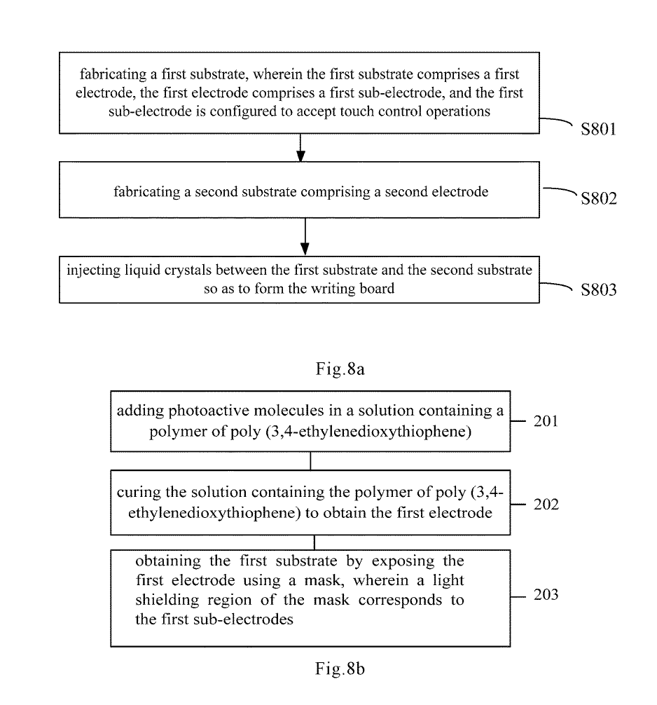

Moreover, an embodiment of the disclosure provides a method for fabricating a writing board. As illustrated in FIG. 8a, the method comprises:

S801: fabricating a first substrate, wherein the first substrate comprises a first electrode, the first electrode comprises a first sub-electrode, and the first sub-electrode is configured to accept touch control operations, as an example, accept touch control operations of an operating object such as a stylus;

S802, fabricating a second substrate comprising a second electrode;

S803, injecting liquid crystals between the first substrate and the second substrate so as to form the writing board.

Moreover, according to at least one embodiment of the disclosure, the method may further comprises:

101, fabricating a first substrate, wherein the first substrate comprises a first electrode, the first electrode includes first sub-electrodes arranged into an array, and the first sub-electrodes comprise a contact surface contacting a stylus;

102, fabricating a second substrate comprising a second electrode;

103, injecting cholesteric liquid crystals between the first substrate and the second substrate so as to form the writing board.

As illustrated in FIG. 8b, the step 101 may specifically comprise the following steps 201-203.

201, adding photoactive molecules in a solution containing a polymer of poly (3,4-ethylenedioxythiophene).

Photoactive molecules are sensitive to lights and can chemically react under a certain light intensity, thus a electrical conductivity of the solution containing the polymer of poly (3,4-ethylenedioxythiophene), i.e., PEDOT material can be reduced that is, a passivation process occurs.

Exemplarily, a material of the photoactive molecules may be benzoin ethyl ether or benzoin isopropyl ether, etc. It is not limited in the embodiments of the disclosure.

202, curing the solution containing the polymer of poly (3,4-ethylenedioxythiophene) to obtain the first electrode.

Exemplarily, the solution containing the PEDOT material may be cured through ways such as ultraviolet (UV) rays exposure so as to form a first electrode having a certain thickness, i.e., the first electrode 101.

Optionally, a wavelength of UV ray is 360-420 nm, and an exposure energy of the UV exposure is 5-50 mW.

203, obtaining the first substrate by exposing the first electrode using a mask, wherein a light shielding region of the mask corresponds to the first sub-electrodes.

As an example, because the light shielding region of the mask corresponds to the first sub-electrodes, when the first electrode is exposed by using the mask, the passivation process occurs on the photoactive molecules in the exposing region of the first electrode, thus the first electrode in the exposing region is not conductive, thereby the non-conducting portion 112 is formed shown in FIG. 4 or FIG. 5.

Correspondingly, the non-exposed regions of the first electrode still have the high electrical conductivity of PEDOT material, thus the sub-electrodes 111 in FIG. 4 or FIG. 5 is formed, and the first electrode formed by the sub-electrodes 111 and the non-conducting portion 112 is just the above-mentioned first substrate.

The embodiments of the disclosure provide a writing board, an electronic writing device and a method for fabricating the same. The writing board comprises: a first substrate and a second substrate opposed to each other, and cholesteric liquid crystals filled in-between the first substrate and the second substrate, wherein the first substrate comprises a first electrode, the second substrate comprises a second electrode, the first electrode comprises a plurality of first sub-electrodes arranged into an array, and the first sub-electrodes comprise a contact surface contacting a stylus. Due to the above configuration, when patterns have been displayed on the writing board under pressure, the stylus may contact the first sub-electrodes through the contact surface. When an end of the stylus contacting the first sub-electrodes is electrified, because the first sub-electrodes is conductive, it is possible to form an electric potential difference between the first sub-electrodes in the contacting position and the second electrode, thus an electric field between the contacting position and the second electrode is formed, thereby the cholesteric liquid crystals corresponding to the contacting position is transformed from planar texture to focal conic texture. However, the cholesteric liquid crystals having a focal conic texture have no reflex to light. Therefore, the patterns on the contact position may be erased, thereby the texts and patterns on the writing board 100 can be erased selectively.

In the description of the disclosure, specific features, structures, materials and characteristics may be combined as needed in one or more embodiments.

Those skilled in the art can make various modifications and variations to the present disclosure without departing from the spirit and scope thereof. Thus, if these modifications and variations of the present disclosure are within the scope of the claims of the invention as well as their equivalents, the present disclosure is also intended to include these modifications and variations.

The present application claims priority from Chinese Application No. 201610078130.6, filed on Feb. 3, 2016, the disclosure of which is incorporated herein by reference in its entirety.

What is claimed is:

1. A writing board, comprising: a first substrate and a second substrate opposed to each other, and liquid crystals filled between the first substrate and the second substrate, wherein the first substrate comprises a first electrode, the second substrate comprises a second electrode, the first electrode comprises a plurality of first sub-electrodes, and the first sub-electrodes are configured to accept touch control operations.

2. The writing board according to claim 1, wherein the first sub-electrodes are configured to accept touch control operations from a stylus, and the first sub-electrodes comprise a contact surface contacting the stylus.

3. The writing board according to claim 2, wherein the first sub-electrodes are arranged into an array.

4. The writing board according to claim 1, wherein the first substrate further comprises a non-conducting portion separating the first sub-electrodes from each other.

5. The writing board according to claim 4, wherein the non-conducting portion is disposed on a plane where the first electrode is located.

6. The writing board according to claim 5, wherein the first sub-electrodes and the non-conducting portion comprise a polymer of poly (3,4-ethylenedioxythiophene).

7. The writing board according to claim 1, wherein the first sub-electrodes are square-shaped.

8. The writing board according to claim 1, wherein a side length of the first sub-electrodes is 50 μm-100 μm.

9. The writing board according to claim 1, wherein a distance between two adjacent first sub-electrodes is 30 μm-50 μm.

10. The writing board according to claim 1, wherein a base is disposed on a side of the second substrate, the side is far from the first substrate.

11. The writing board according to claim 1, wherein the liquid crystals are cholesteric liquid crystals.

12. The writing board according to claim 1, wherein the second substrate further comprises a base substrate, and the second electrode is disposed on a side of the base substrate, the side is close to the first substrate.

13. The writing board according to claim 12, wherein a base is disposed on a side of the base substrate far from the first substrate.

14. An electronic writing device, comprising a writing board and a stylus, wherein
the writing board comprises: a first substrate and a second substrate opposed to each other, and liquid crystals filled between the first substrate and the second substrate, the first substrate comprises a first electrode, the second substrate comprises a second electrode, the first electrode comprises a plurality of first sub-electrodes, and the first sub-electrodes is configured to accept touch of the stylus; and
the stylus comprises a first nib and the first nib is conductive.

15. The electronic writing device according to claim 14, wherein the stylus further comprises a second nib and the second nib is not conductive.

16. The electronic writing device according to claim 14, wherein a battery is disposed in the stylus and configured for providing a voltage for the first nib.

17. The electronic writing device according to claim 16, wherein a switch unit is disposed in the stylus, and the switch unit, the battery and the first nib are connected in series.

18. A method for fabricating a writing board, comprising:
fabricating a first substrate, wherein the first substrate comprises a first electrode, the first electrode comprises a first sub-electrode, and the first sub-electrode is configured to accept touch control operations;
fabricating a second substrate comprising a second electrode; and
injecting liquid crystals between the first substrate and the second substrate so as to form the writing board.

19. The method according to claim 18, wherein the step of fabricating a first substrate comprises:
adding photoactive molecules in a solution containing a polymer of poly (3,4-ethylenedioxythiophene);
curing the solution containing the polymer of poly (3,4-ethylenedioxythiophene) to obtain the first electrode;
obtaining the first substrate by exposing the first electrode using a mask, wherein a light shielding region of the mask corresponds to the first sub-electrode.

20. The method according to claim 18, wherein the liquid crystals are cholesteric liquid crystals, the first sub-electrodes has a contact surface which contacts a stylus and is configured to accept touch control operations.
